(19) United States
(12) Patent Application Publication
(10) Pub. No.: US 2023/0223635 A1
(43) Pub. Date: Jul. 13, 2023

(54) VEHICLE BATTERY MOUNTING STRUCTURE

(71) Applicants: HYUNDAI MOTOR COMPANY, Seoul (KR); KIA CORPORATION, Seoul (KR)

(72) Inventor: Seung Min Jeong, Hwaseong-si (KR)

(73) Assignees: HYUNDAI MOTOR COMPANY, Seoul (KR); KIA CORPORATION, Seoul (KR)

(21) Appl. No.: 17/892,872

(22) Filed: Aug. 22, 2022

(30) Foreign Application Priority Data
Jan. 11, 2022 (KR) 10-2022-0004231

(51) Int. Cl. H01M 50/262; H01M 50/242; H01M 50/249

(52) U.S. Cl. CPC H01M 50/262; H01M 50/242; H01M 50/249; H01M 2220/20

(57) ABSTRACT

A vehicle battery mounting structure includes a battery case, which has a reinforcing member disposed between battery modules therein. The mounting structure includes battery side members, which have a plurality of closed cross-sections, are provided on opposite sides of the battery case, respectively, and are coupled to lower sides of frame side members. The mounting structure further includes a middle through-fastener, which extends through the reinforcing member of the battery case and is coupled to a vehicle body cross member.

### CROSS-REFERENCE TO RELATED APPLICATION(S)

This application is based on and claims priority under 35 U.S.C. 119 to Korean Patent Application No. 10-2022-0004231, filed on Jan. 11, 2022, in the Korean Intellectual Property Office, the disclosure of which is herein incorporated by reference in its entirety.

### BACKGROUND

### 1. Technical Field

The disclosure relates to a technology for mounting a high-voltage battery to an electric car or the like.

### 2. Description of the Prior Art

A purpose-built vehicle (PBV) refers to a vehicle configured to couple a drive module related to driving a vehicle in accordance with market trends toward multi-type, low volume production. A PBV also refers to a vehicle designed to couple a life module configured to form various types of riding and loading spaces according to market demands.

Therefore, by changing the life module only, there is an advantage in that vehicles conforming to market demands can be quickly produced.

Furthermore, in line with recent trends toward eco-friendly vehicle technologies, development tends to be made such that the drive module is equipped with a high-voltage battery (hereinafter, simply referred to as “battery”).

The above descriptions regarding background technologies have been made only to help understand the background of the disclosure. Therefore, the above descriptions are not to be deemed by those having ordinary skill in the art to correspond to already-known prior arts.

### SUMMARY

It is an aspect of the disclosure to provide a purpose-built vehicle (PBV) battery mounting structure. By ensuring that a battery can be mounted on the lower side of a PBV more firmly and stably, safety of the vehicle against lateral collision is improved. Further, the floor strength of the PBV, which tends to have a flat-floor, is reinforced such that the noise vibration harshness (NVH) performance of the floor can be improved.

In accordance with an aspect of the disclosure, a PBV battery mounting structure may include a battery case having a reinforcing member that is disposed between battery modules therein and having battery side members that have a plurality of closed cross-sections. The battery side members may be provided on opposite sides of the battery case, respectively, and may be coupled to the lower sides of the frame side members. Further, the PBV battery mounting structure may include a middle through-fastener extending through the reinforcing member of the battery case and coupled to a vehicle body cross member.

The battery side members and the frame side members may be coupled by a plurality of side through-fasteners. The plurality of side through-fasteners may be inserted from the lower sides of the battery side members.

The side through-fasteners may extend through the frame side members to be coupled to the vehicle cross member.

The battery side members may have battery side spacers through which the side through-fasteners extend and which are provided at portions where the side through-fasteners are fastened. Further, the frame side members may have frame side spacers through which the side through-fasteners extend and which are provided at portions where the side through-fasteners are fastened.

The reinforcing member of the battery case may include a vertical member disposed along a longitudinal direction of a vehicle and a horizontal member disposed along a horizontal direction of a vehicle. Further, the middle through-fastener may extend through at least one of the vertical member and horizontal member to be fastened.

The vehicle body cross member may be disposed on a lower side of the floor panel along a horizontal direction of the vehicle body so that opposite ends thereof are coupled to side sills. Further, the battery case may have a mounting bushing into which the middle through-fastener is inserted, and which provides support between an upper cover and a lower cover of the battery case.

The vehicle body cross member may have a W-shaped cross-section in which one convex portion is formed between two concave portions. Further, the middle through-fastener or bolt may extend through and be fastened to a lower bracket, which connects the lower sides of the two concave portions.

The vehicle body cross member may have a U-shaped cross-section, which has one concave portion. Further, the middle through-fastener may extend through and be fastened to the concave portion.

A reinforcing plate may overlap the concave portion of the vehicle body cross member. Further, the middle through-fastener may extend through and be fastened to the reinforcing plate and the concave portion of the vehicle body cross member.

The vehicle body cross member may be disposed on an upper side of the floor panel along a horizontal direction of the vehicle body so that the opposite ends thereof are coupled to side sills. Further, the battery case may have a mounting bushing into which the middle through-fastener is inserted, and which provides support between an upper cover and a lower cover of the battery case.

The vehicle body cross member may have an M-shaped cross-section in which one concave portion is provided between two convex portions. Further, the middle through-fastener may extend through the floor panel and the concave portion of the vehicle body cross member so as to be fastened thereto.

The vehicle body cross member may have an inverted U-shaped cross-section, which has one convex portion. The middle through-fastener may extend through and be fastened to a reinforcing bracket, which overlaps an upper side of the floor panel and protects a lower side surface of the vehicle body cross member.

The vehicle body cross member may be disposed along a horizontal direction of the vehicle body so that opposite ends thereof are coupled to side sills. The side sill reinforcing materials are formed of closed cross-sections, which may be provided in the side sills, respectively.

The vehicle body cross member may be disposed along a horizontal direction of a vehicle body to overlap a floor panel of a life module. The frame side members may constitute a frame of a drive module and the frame may have a plurality of frame cross members, which connect the frame side members.

The frame side members may constitute a frame together with a plurality of frame cross members. The frame cross member may be installed to avoid a portion in which the battery case is mounted. Opposite ends of the battery case may be coupled to the frame side members. Further, a central portion of the battery case may be coupled to the vehicle body cross member provided at a vehicle body.

The battery case may be installed to have a height so as to overlap the frame side members in the vertical direction of the vehicle.

The disclosed mounting structure is advantageous in that, by ensuring that a battery can be mounted on the lower side of a PBV more firmly and stably, safety of the vehicle against lateral collisions is improved. Further, the floor strength of the PBV, which has a tendency to be have flat floor, is reinforced such that the noise vibration harshness (NVH) performance of the floor can be improved.

### BRIEF DESCRIPTION OF THE DRAWINGS

The above and other aspects, features, and advantages of the disclosure should be more apparent from the following detailed description taken in conjunction with the accompanying drawings, in which:

FIG. 1 is a view illustrating a purpose-built vehicle (PBV) to which a battery mounting structure can be applied according to the disclosure;

FIG. 2 is a bottom view of a PBV to which a battery mounting structure is applied according to the disclosure;

FIG. 3 is a view illustrating a battery structure mounted on a PBV;

FIG. 4 is a cross-sectional view taken along line IV-IV in FIG. 2;

FIG. 5 is a view illustrating an example in which a side through-fastener is coupled to a vehicle body cross member;

FIG. 6 is a view illustrating a battery side spacer and a frame side spacer;

FIG. 7 is a cross-sectional view taken along line VII-VII in FIG. 2 and illustrating a first embodiment in which a middle through-fastener is coupled to a vehicle body cross member;

FIG. 8 is a view illustrating a second embodiment in which a middle through-fastener is coupled to a vehicle body cross member;

FIG. 9 is a view illustrating a third embodiment in which a middle through-fastener is coupled to a vehicle body cross member;

FIG. 10 is a view illustrating a fourth embodiment in which a middle through-fastener is coupled to a vehicle body cross member; and

FIG. 11 is a view illustrating a fifth embodiment in which a middle through-fastener is coupled to a vehicle body cross member.

### DETAILED DESCRIPTION OF THE EMBODIMENTS

A specific structural or functional description of embodiments of the present disclosure, set forth in the specification or application, is given merely for the purpose of describing the embodiments according to the present disclosure. Therefore, the embodiments according to the present disclosure may be implemented in various forms, and the present disclosure should not be construed as being limited to the embodiments described in the specification or application.

Various changes and modifications may be made to the embodiments according to the present disclosure. Therefore, particular embodiments are illustrated in the drawings and described in the specification or application. However, it should be understood that embodiments according to the concept of the present disclosure are not limited to the particular disclosed embodiments. Instead, the present disclosure includes all modifications, equivalents, and alternatives falling within the spirit and scope of the present inventive concept.

Such terms as “a first” and/or “a second” may be used to describe various elements, but the elements should not be limited by these terms. These terms are intended merely to distinguish one element from other elements. For example, a first element may be named a second element and, similarly, a second element may be named a second element without departing from the scope of protection of the present disclosure.

Where an element is referred to as being “connected” or “accessed” to other elements, it should be understood that not only the element is directly connected or accessed to the other elements, but also another element may exist between them. Contrarily, where a component is referred to as being “directly connected” or “directly accessed” to any other component, it should be understood that there is no other component therebetween. Other expressions of describing a relation between structural elements, i.e., “between” and “merely between” or “neighboring” and “directly neighboring,” should be interpreted similarly to the above description.

The terms used in the present disclosure are merely used to describe specific embodiments and are not intended to limit the present disclosure. A singular expression may include a plural expression unless they are definitely different in context. As used herein, the expressions “include” or “have” are intended to specify the existence of mentioned features, numbers, steps, operations, elements, components, or combinations thereof, and should be construed as not precluding the possible existence or addition of one or more other features, numbers, steps, operations, elements, components, or combinations thereof.

Unless defined otherwise, all terms used herein, including technical and scientific terms, have the same meaning as those commonly understood by a person having ordinary skill in the art to which the present disclosure pertains. Such terms as those defined in a generally used dictionary may be interpreted to have the meanings consistent with the contextual meanings in the relevant field of art. Such terms are not to be interpreted to have ideal or excessively formal meanings unless clearly defined in the present disclosure.

Hereinafter, embodiments of the present disclosure are described in detail with reference to the accompanying drawings. Similar or like reference signs presented in the respective drawings designate similar or like elements.

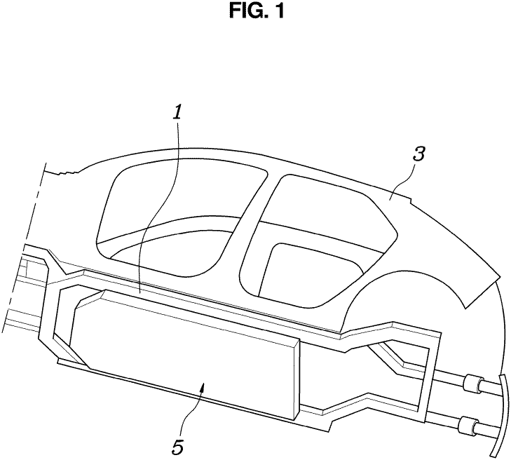

FIG. 1 illustrates a purpose-built vehicle (PBV) to which the disclosure can be applied. A frame 1 constituting a drive module and a vehicle body 3 constituting a life module are coupled. Further, a battery 5 is mounted on a lower side of the vehicle body 3 and frame 1.

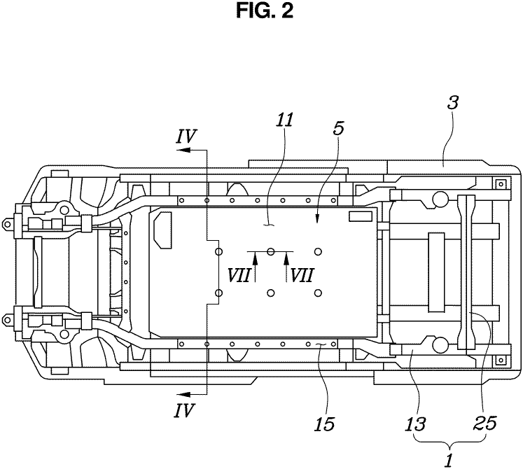

Referring to FIGS. 2-4, a battery mounting structure of a PBV of the disclosure includes a battery case 11, which has a reinforcing member 9 disposed between battery modules 7 therein. The battery mounting structure also includes battery side members 15, which have a plurality of closed cross-sections. The battery side members 15 are provided on opposite sides of the battery case 11 and are coupled to lower sides of frame side members 13. The battery mounting structure further includes one or more middle through-fasteners 19, which extend through the reinforcing member 9 of the battery case 11 and are coupled to a vehicle body cross member 17.

In addition, the battery side member 15 and the frame side member 13 are coupled by a plurality of side through-fasteners 21 inserted from a lower side of the battery side member 15.

For reference, the term ‘fastener’ is used herein as a generic name for a connection mechanism for coupling a plurality of members or components. The noted fasteners may be bolts, rivets, screws, and the like.

The vehicle body cross member 17 is disposed lengthwise along a horizontal direction of the vehicle body 3 to overlap a floor panel 23 of the vehicle body 3. The frame side members 13 constitute the frame 1, and the frame 1 constitutes a drive module. The frame 1 has a plurality of frame cross members 25 for connecting the frame side members 13.

In other words, in the disclosure, the battery case 11 has a structure fixed to the vehicle body 3 and frame 1. The battery side members 15, of or on opposite sides of the battery case 11, are coupled to the frame side members 13 by the side through-fasteners 21. In this embodiment, a plurality of the middle through-fasteners 19 extend through the battery case 11 to be coupled to the vehicle body cross member 17.

As described above, the frame 1 has a shape in which the plurality of frame cross members 25 connect the frame side members 13 of opposite sides of a vehicle. In the disclosure, the frame cross members 25 are installed to avoid a portion in which the battery case 11 is mounted.

In other words, as illustrated in FIG. 2, the battery case 11 is positioned in a middle portion of the frame 1 so that the frame cross member 25 is not provided in the portion in which the battery case 11 is positioned. Further, the plurality of frame cross members 25 are provided only in other portions so as to connect the frame side members 13 on opposite sides.

Therefore, in the disclosure, the battery case 11 has opposite ends, which are coupled to the frame side members 13. The central portion of the battery case 11 is coupled to the vehicle body cross member 17 provided at the vehicle body 3 instead of the frame 1.

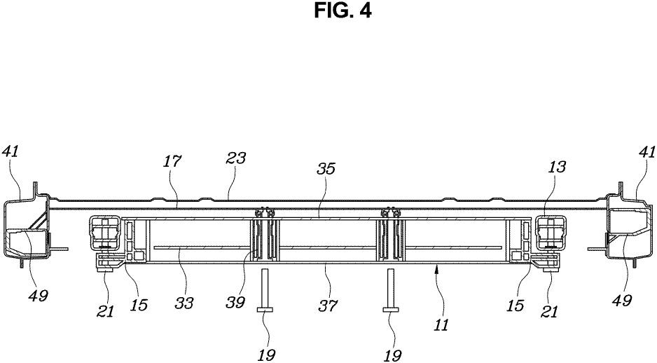

In addition, the battery case 11 may not interfere with the frame cross member 25 and may be positioned where the frame cross member 25 is not installed. As in FIGS. 4-6, the battery case 11 may be installed to have a height so as to overlap the frame side member 13 in the vertical direction of the vehicle.

This may improve the capacity and safety of the battery mounted on the vehicle and may significantly increase the degree of freedom in design from the viewpoint of ensuring an appropriate ground clearance of the vehicle.

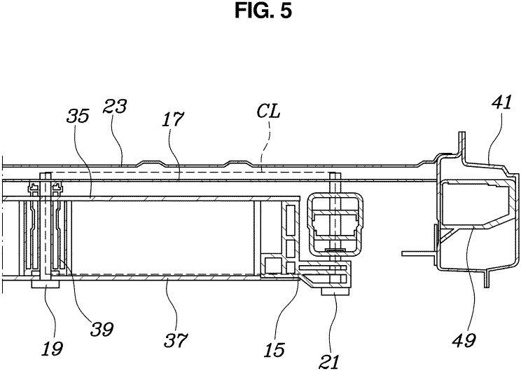

As illustrated above, the side through-fastener 21 may be coupled to the frame side member 13 on each side of the vehicle and the frame side member 13 may be coupled to the vehicle body 3 via a separate mounting unit. However, as illustrated in FIG. 5, each side through-fastener 21 may extend through the frame side member 13 and may be coupled to the vehicle body cross member 17.

In the structure described above, a closed curve CL formed by the vehicle body cross member 17, the middle through-fasteners 19, the battery case 11, and the side through-fastener 21 may provide greater rigidity against side collisions.

A structure in which the side through-fasteners 21 are connected only to the frame side members 13, and a structure in which the side through-fasteners 21 extend through the frame side members 13 to be connected to the vehicle body cross member 17 may be respectively used or may be used interchangeably with each other.

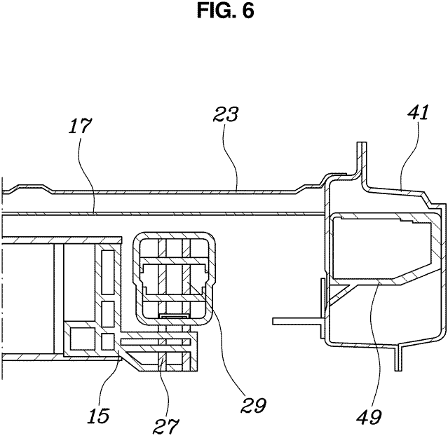

As illustrated in FIG. 6, the battery side member 15 has a battery side spacer 27 through which the side through-fastener 21 extends on each side of the vehicle and which is provided at a portion where the side through-fastener 21 is fastened. The frame side member 13 has a frame side spacer 29 through which the side through-fastener 21 extends and which is provided at a portion where the side through-fastener 21 is fastened.

With the above configuration, since the fastening force of the side through-fasteners 21 may be set even stronger, the fastening state of the side through-fasteners 21 may be secured more firmly. Thus, the configuration described above may provide greater rigidity against vehicle side collisions.

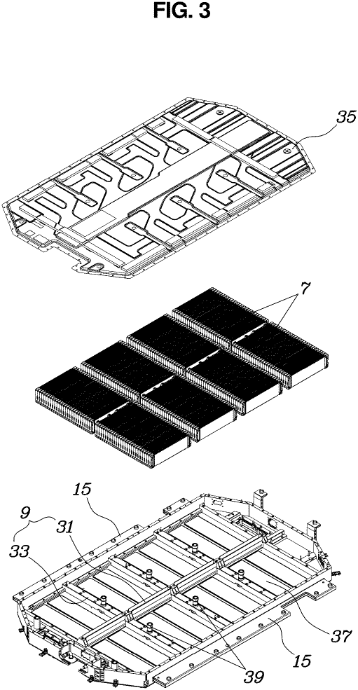

As illustrated in FIG. 3, the reinforcing member 9 of the battery case 11 includes a vertical member 31 disposed along a longitudinal direction of a vehicle and a horizontal member 33 disposed along a horizontal direction of a vehicle. The middle through-fasteners 19 extend through at least one of the vertical member 31 and horizontal member 33 to be fastened.

In addition, the battery case 11 has a mounting bushing 39 into which each middle through-fastener 19 is inserted and which provides support between an upper cover 35 and a lower cover 37 of the battery case 11.

The plurality of middle through-fasteners 19 as described above extend through the vertical member 31 or the horizontal member 33 as described above to be coupled to the vehicle body cross member 17 coupled to the floor panel 23. Thus, a heavy battery 5 is firmly connected to a floor of a PBV, which substantially tends to be a flat floor, by the plurality of middle through-fasteners 19 described above so as to compensate for the strength against the load applied to the floor panel 23 and to improve NVH performance.

The vehicle body cross member 17 may be disposed on a lower side of the floor panel 23 along a horizontal direction of the vehicle body 3 so that opposite ends thereof are coupled to side sills 41.

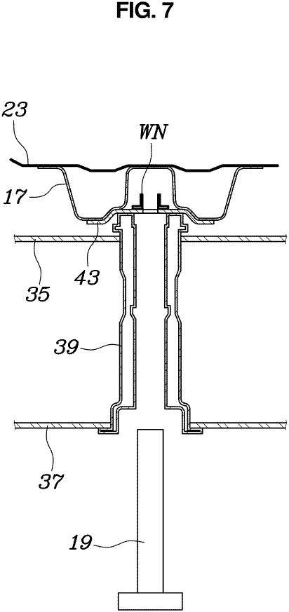

FIG. 7 illustrates a first embodiment in which each middle through-fastener 19 is coupled to the vehicle body cross member 17. The vehicle body cross member 17 has a W-shaped cross-section in which one convex portion is formed between two concave portions. The middle through-fastener 19 extends through and is fastened to a lower bracket 43, which connects the lower sides of the two concave portions.

The lower bracket 43 may be coupled to the lower side of the two concave portions by welding or the like. Further, a weld nut WN to which each middle through-fastener 19 is fastened may be integrally provided on an upper side of the lower bracket 43.

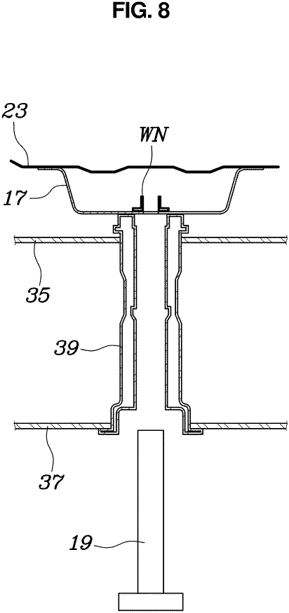

FIG. 8 illustrates a second embodiment in which each middle through-fastener 19 is coupled to the vehicle body cross member 17. The vehicle body cross member 17 may have a U-shaped cross-section which has one concave portion. The middle through-fasteners 19 may extend through and be fastened to the concave portion.

Therefore, a weld nut WN to which each middle through-fastener 19 is fastened may be integrally provided on an upper side of the concave portion of the vehicle body cross member 17.

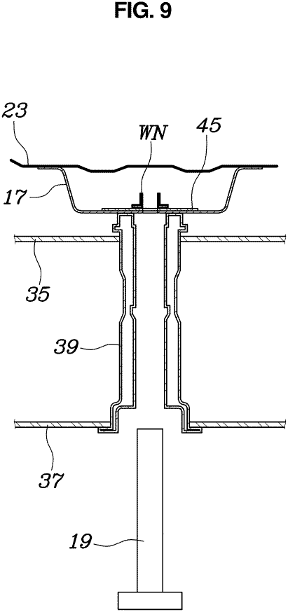

FIG. 9 illustrates a third embodiment in which each middle through-fastener 19 is coupled to the vehicle body cross member 17. The vehicle body cross member 17 has a U-shaped cross-section, which has one concave portion. A reinforcing plate 45 overlaps the concave portion of the vehicle body cross member 17. The middle through-fasteners 19 extend through and may be fastened to the reinforcing plate 45 and the concave portion of the vehicle body cross member 17.

Of course, weld nuts WN to which the middle through-fasteners 19 are fastened may be provided on an upper side of the reinforcing plate 45.

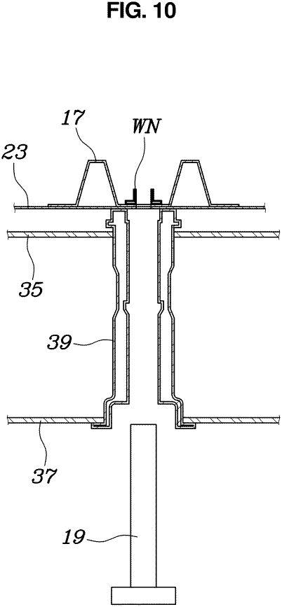

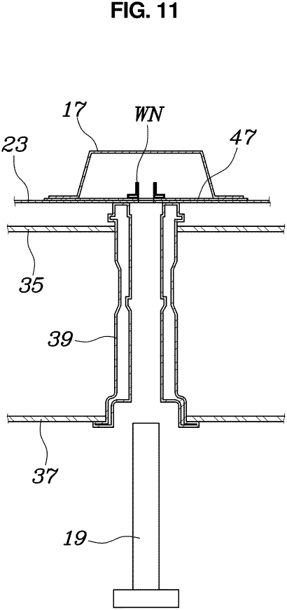

The vehicle body cross member 17 is provided on a lower side of the floor panel 23 in the first embodiment to the third embodiment of FIGS. 7-9. However, the vehicle body cross member 17 may be provided on an upper side of the floor panel 23 as in FIG. 10 and FIG. 11.

In a fourth embodiment of FIG. 10, the vehicle body cross member 17 has an M-shaped cross-section in which one concave portion is provided between two convex portions. Further, each middle through-fastener 19 extends through the floor panel 23 and the concave portion of the vehicle body cross member 17 in order to be fastened thereto.

Therefore, a weld nut WN to which each middle through-fastener 19 is fastened may be integrally formed on an upper side of the concave portion of the vehicle body cross member 17.

In a fifth embodiment of FIG. 11, the vehicle body cross member 17 has an inverted U-shaped cross-section, which has one convex portion. Further, each middle through-fastener 19 extends through and is fastened to a reinforcing bracket 47, which overlaps an upper side of the floor panel 23 and protects a lower side surface of the vehicle body cross member 17.

Therefore, a weld nut WN to which each middle through-fastener 19 is fastened may be integrally provided on an upper side of the reinforcing bracket 47.

Referring to FIG. 3, the vehicle body cross member 17 may be disposed along a horizontal direction of the vehicle body 3 so that opposite ends thereof are coupled to the side sills 41. A side sill reinforcing material 49 formed of closed cross-sections may be provided in the side sills 41.

When the side sill reinforcing material 49 is inserted into the side sill 41, as described above, it is possible to secure stronger rigidity against a side collision of the vehicle so that it may better protect the battery 5.

In an embodiment, the side sill reinforcing material 49 is coupled with the inside of a side sill 41 so as to be integrated with the side sill 41 in various methods, such as welding or bolting.

The inventive concept of the present disclosure has been described and illustrated in conjunction with particular embodiments thereof. However, it should be apparent to those having ordinary skill in the art that various improvements and modifications may be made to the present disclosure without departing from the technical idea of the present disclosure defined by the appended claims.

What is claimed is:

1. A vehicle battery mounting structure comprising:
a battery case, which has a reinforcing member disposed between battery modules therein;
battery side members, which have a plurality of closed cross-sections, are provided on opposite sides of the battery case, respectively, and are coupled to lower sides of frame side members; and
a middle through-fastener, which extends through the reinforcing member of the battery case and is coupled to a vehicle body cross member.

2. The vehicle battery mounting structure of claim 1, wherein the battery side members and the frame side members are coupled by a plurality of side through-fasteners inserted from lower sides of the battery side members.

3. The vehicle battery mounting structure of claim 2, wherein the side through-fasteners extend through the frame side members to be coupled to the vehicle cross member.

4. The vehicle battery mounting structure of claim 3, wherein the battery side members have battery side spacers through which the side through-fasteners extend and which are provided at portions where the side through-fasteners are fastened, and
wherein the frame side members have frame side spacers through which the side through-fasteners extend and which are provided at portions where the side through-fasteners are fastened.

5. The vehicle battery mounting structure of claim 2, wherein the reinforcing member of the battery case includes a vertical member disposed along a longitudinal direction of a vehicle and includes a horizontal member disposed along a horizontal direction of a vehicle, and
wherein the middle through-fastener extends through at least one of the vertical member and horizontal member to be fastened.

6. The vehicle battery mounting structure of claim 1, wherein the vehicle body cross member is disposed on a lower side of a floor panel along a horizontal direction of the vehicle body so that opposite ends thereof are coupled to side sills, and
wherein the battery case has a mounting bushing into which the middle through-fastener is inserted, and which provides support between an upper cover and a lower cover of the battery case.

7. The vehicle battery mounting structure of claim 6, wherein the vehicle body cross member has a W-shaped cross-section in which one convex portion is formed between two concave portions, and
wherein the middle through-fastener extends through and is fastened to a lower bracket, which connects lower sides of the two concave portions.

8. The vehicle battery mounting structure of claim 6, wherein the vehicle body cross member has a U-shaped cross-section, which has one concave portion, and
wherein the middle through-fastener extends through and is fastened to the concave portion.

9. The vehicle battery mounting structure of claim 8, wherein a reinforcing plate overlaps the concave portion of the vehicle body cross member, and
wherein the middle through-fastener extends through and is fastened to the reinforcing plate and the concave portion of the vehicle body cross member.

10. The vehicle battery mounting structure of claim 1, wherein the vehicle body cross member is disposed on an upper side of a floor panel along a horizontal direction of the vehicle body so that opposite ends thereof are coupled to side sills; and
wherein the battery case has a mounting bushing into which the middle through-fastener is inserted, and which provides support between an upper cover and a lower cover of the battery case.

11. The vehicle battery mounting structure of claim 10, wherein the vehicle body cross member has an M-shaped cross-section in which one concave portion is provided between two convex portions, and
wherein the middle through-fastener extends through the floor panel and the concave portion of the vehicle body cross member so as to be fastened thereto.

12. The vehicle battery mounting structure of claim 10, wherein the vehicle body cross member has an inverted U-shaped cross-section, which has one convex portion, and
wherein the middle through-fastener extends through and is fastened to a reinforcing bracket, which overlaps an upper side of the floor panel and protects a lower side surface of the vehicle body cross member.

13. The vehicle battery mounting structure of claim 1, wherein the vehicle body cross member is disposed along a horizontal direction of the vehicle body so that opposite ends thereof are coupled to side sills; and
wherein side sill reinforcing materials formed of closed cross-sections are provided in the side sills, respectively.

14. The vehicle battery mounting structure of claim 1, wherein the vehicle body cross member is disposed along a horizontal direction of a vehicle body to overlap a floor panel of a life module,
wherein the frame side members constitute a frame of a drive module, and
wherein the frame has a plurality of frame cross members, which connect the frame side members.

15. The vehicle battery mounting structure of claim 1, wherein the frame side members constitute a frame together with a plurality of frame cross members,
wherein the frame cross member is installed to avoid a portion in which the battery case is mounted,
wherein opposite ends of the battery case are coupled to the frame side members, and
wherein a central portion of the battery case is coupled to the vehicle body cross member provided at a vehicle body.

16. The vehicle battery mounting structure of claim 15, wherein the battery case is installed to have a height so as to overlap the frame side members in a vertical direction of the vehicle.
